(19) United States
(12) Patent Application Publication
(10) Pub. No.: US 2024/0166056 A1
(43) Pub. Date: May 23, 2024

(54) ELECTRODYNAMIC WHEEL MAGLEV VEHICLE WITH A PASSIVE U-GUIDEWAY

(71) Applicant: Portland State University, Portland, OR (US)

(72) Inventors: Jonathan Bird, Portland, OR (US); Colton Bruce, Portland, OR (US)

(21) Appl. No.: 18/511,803

(22) Filed: Nov. 16, 2023

Related U.S. Application Data
(60) Provisional application No. 63/384,392, filed on Nov. 18, 2022.

(51) Int. Cl. B60L 13/04; B61B 13/08

(52) U.S. Cl. CPC B60L 13/04; B61B 13/08

(57) ABSTRACT

Embodiments are generally directed to a six-degree of freedom electrodynamic wheel (EDW) magnetic levitation (maglev) vehicle that can stably levitate over a passive low-cost U-guideway. The U-guideway can be composed of two sections of L-track aluminum sheet. The EDW-maglev vehicle can contain four one pole-pair diametric magnetized magnets that are driven using a low-cost motor and motor controller. No advanced controls are needed to provide basic stability. A 3-D transient finite element analysis model can be used to study the 3-D forces created when the magnets are rotated over the aluminum L-track. In addition to providing lateral recentering force, the L-track can also be used to increase thrust and lift force.

### CROSS REFERENCE TO RELATED APPLICATIONS

This application claims priority to U.S. Provisional Application No. 63/384,392, entitled “ELECTRODYNAMIC WHEEL MAGLEV VEHICLE WITH A PASSIVE U-GUIDEWAY,” and filed Nov. 18, 2022, the entire contents of which are hereby incorporated by reference for all purposes.

### GOVERNMENT SUPPORT

This invention was made with government support under Grant No. 1810489 awarded by the National Science Foundation. The U.S. Government has certain rights in the invention.

### FIELD

The disclosure relates to electrodynamic maglev vehicles and, more particularly, to radial and axial electrodynamic wheel (EDW) maglev vehicles that can stably levitate and translate above a low-cost U-guideway.

### BACKGROUND AND SUMMARY

Electrodynamic maglev vehicles use magnets to induce currents within conductive track material. The induced currents create an opposing field which can be utilized to create levitation, thrust, and guidance forces. Electrodynamic maglev vehicles are being studied for use in ultra-high-speed ground transportation applications as well as in lower speed maglev vehicles. Maglev vehicles offer trip times that are competitive with aircraft and can be powered with electricity created from renewable energy sources. Maglev vehicles' non-contact operation allows them to operate in harsh environments and operate on steep gradients. To lower the cost of maglev transportation the maglev track can be passive. To accomplish this the maglev vehicle can be the initial field source, rather than the track.

Inducing current within a passive conductive track guideway by rotating magnets, rather than simply translating magnets, enables both a lift and thrust force to be simultaneously created. The use of rotating magnets can create a relatively high lift-to-weight ratio. In addition, when using magnets, the reactive field setup between the conductive track and magnet rotor is shielded from the driving motor.

In the past, both radial and axial electrodynamic wheel (EDW) configurations, as illustrated in FIGS. 1A and 1B, have been studied. As the radial EDW's rolling motion is in the same direction as the travelling direction, the difference in the rotating magnet's circumferential speed relative to the translational speed can be controlled to give rise to both a thrust force, Fₓ, as well as a lift force, F_{y}. However, as the airgap is non-uniform, only a small portion of the magnet material is utilized at any given time.

The axial rotor EDW has a uniform airgap with the flat track leading to a higher lift-to-weight ratio, but no thrust force is then created. To additionally produce thrust, the axial rotor can be tilted, creating a non-uniform air-gap and asymmetric current flow, or the axial rotor can create thrust by using the track edge-effect. This also creates an asymmetric current flow. While these axial EDW designs allow the axial EDW to create thrust, they will also significantly lower the lift force, reducing the benefits of the axial EDW relative to the radial configuration. By adding a rotor shield or adding supplemental rotor windings a rotor magnet field asymmetry can be created, reducing the field on one side of the magnet rotor; this can then give rise to a thrust force. But the use of a conductive rotor magnet shield will greatly increase loss and the addition of rotor windings around the magnets will significantly increase complexity as well as loss.

Both the radial and axial EDWs are laterally unstable when placed over a flat guideway sheet. If a single flat track is used, like that shown in FIG. 1, the magnet rotors will try to minimize their energy by catastrophically exiting in the lateral, z-axis, direction. To intuitively understand this lateral instability, consider the case where a magnet is moving over a finite-width ladder track, as shown in FIG. 2. For illustrative purposes consider the influence of the mutual inductance between the track and moving magnet. In this case, the electromagnetic mutual energy in lumped-parameter form will be:

$$\\ \begin{matrix}{E}_{m} = \frac{1}{2} {M}_{tm} ( x , 𝓏 ) {i}_{t} ( x , 𝓏 ) {i}_{m} + \frac{1}{2} {M}_{mt} ( x , 𝓏 ) {i}_{t} ( x , 𝓏 ) {i}_{m} & Eq . ( 1 )\end{matrix}$$

where i_{g} is the induced loop current and iₘ=fictious magnet current that creates the magnet field. Since Mₜₘ=Mₘₜ the energy in terms of mutual flux is:

Eₘ(x,z)=Φ(x,z)iₘ Eq. (2)

where Φ=Mₜₘiₜ. The magnetic force acting on the guideway in the lateral z-axis direction can be obtained from the negative energy gradient:

$$\\ \begin{matrix}{F}_{𝓏} = - \frac{\partial {E}_{m}}{\partial 𝓏} & Eq . ( 3 )\end{matrix}$$

Thus, assuming that the magnet source current is not changing and then substituting equation (2) into equation (3) the lateral force will be:

$$\\ \begin{matrix}{F}_{𝓏} = - {i}_{m} \frac{\partial Φ}{\partial 𝓏} & Eq . ( 4 )\end{matrix}$$

From Equation (4) it can be noted that the lateral force will depend on the gradient of the mutual flux. For the magnet guideway configuration shown in FIG. 2 the flux will be a maximum when the magnet is centered over the guideway and therefore the energy profile, Eₘ, as a function of the lateral position, z, and the resultant lateral force, F_{z}, will have the form shown in FIG. 3. Stability can never be assured as a lateral force will always be created to push the magnet off the guideway. This same analysis applies to the EDWs that are shown in FIG. 1.

To provide passive stability, the maglev's magnets need to rest within a mutual energy minimum. One way to create a local energy minimum is to use a split-track guideway. However, by splitting the track, the currents are prevented from circulating below the maximum rotor field location and therefore the split-track greatly reduces the lift and thrust force. The amount of re-centering force is also relatively small and does not scale well with size. Lateral stability can also be created by using a curved track; however, for track design, the EDW does not create thrust and the use of any curved, or wrap-around track, greatly increase the guideway construction and operating cost. Since to enable vehicle lane changing the entire guideway must be moved.

It has also been proposed that active control could be used to create stability, by mechanically rotating the EDW's axis the EDW force direction can be constantly adjusted so as to enable the EDW to be maintained on a single flat guideway; if the EDW rotation controls failed it would lead to a catastrophic crash (like with some aircrafts).

FIG. 4 illustrates an example of an L-track EDW typology in accordance with certain implementations of the disclosed technology. In accordance with certain embodiments, when two L-tracks are combined to form a U-guideway an EDW-maglev vehicle can have 6-degrees-of-freedom stability. Each EDW can be composed of a simple one pole-pair diametrically magnetized rotor magnet. A higher number of EDW rotor pole-pairs could also be used, but a one pole-pair rotor may be used to provide the lowest lift specific power (W/kg), as well as simplify the construction. The one pole-pair radial EDW can operate with a near constant airgap, despite creating relatively high lift force ripple.

It should be understood that the brief description above is provided to introduce in simplified form a selection of concepts that are further described in the detailed description. It is not meant to identify key or essential features of the claimed subject matter, the scope of which is defined uniquely by the claims that follow the detailed description. Furthermore, the claimed subject matter is not limited to implementations that solve any disadvantages noted above or in any part of this disclosure.

### BRIEF DESCRIPTION OF THE DRAWINGS

The patent or application file contains at least one drawing executed in color. Copies of this patent or patent application publication with color drawing(s) will be provided by the Office upon request and payment of the necessary fee.

The disclosure may be better understood from reading the following description of non-limiting embodiments, with reference to the attached drawings, wherein below:

FIG. 1A illustrates an example of a radial EDW topology 100 as known in the art;

FIG. 1B illustrates an example of an axial EDW topology 110 as known in the art;

FIG. 2 illustrates an example of a magnet 200 moving over a conductive guideway 210;

FIG. 3A illustrates an example of a plot 300 illustrating guideway mutual flux, Φ, seen by the track;

FIG. 3B illustrates an example of a plot 310 illustrating mutual energy, Eₘ;

FIG. 3C illustrates an example of a plot 320 illustrating force, F_{z};

FIG. 4A illustrates an example of a 3-D perspective view of a one pole-pair axial EDW over an L-track, including the force components;

FIG. 4B illustrates an example of a 3-D perspective view of a one pole-pair radial EDW over an L-track, including the force components;

FIG. 5A illustrates an example of a front view of an EDW 500 showing the EDW having a lateral offset distance z_{g} from the side-track and and airgap height y_{g}, where the side track length is defined as l_{y};

FIG. 5B illustrates an example of a front view of an EDW 510 showing that when l_{y}=0 the side height is zero and in this case at z_{g}=6.35 mm the EDW is centered over the flat track;

FIG. 6A illustrates an example of a plot 600 showing a 3-D FEA calculated lateral force, F_{z}, a a function of EDW rotor offset, z_{g}, and track-side height, l_{y}, when the angular speed is ω=5000 r/min, in which the geometric and material values shown in Table I and Table II were used, and where the dark blue plotline corresponds to track height 0.0, the orange plotline corresponds to track height 3.175, the yellow plotline corresponds to track height 6.35, the purple plotline corresponds to track height 9.525, the green plotline corresponds to track height 12.7, the light blue plotline corresponds to track height 15.875, and the magenta plotline corresponds to track height 19.05;

FIG. 6B illustrates an example of a plot 610 showing a 3-D FEA calculated lift force, F_{z}, a a function of EDW rotor offset, z_{g}, and track-side height, l_{y}, when the angular speed is ω=5000 r/min, in which the geometric and material values shown in Table I and Table II were used, and where the dark blue plotline corresponds to track height 0.0, the orange plotline corresponds to track height 3.175, the yellow plotline corresponds to track height 6.35, the purple plotline corresponds to track height 9.525, the green plotline corresponds to track height 12.7, the light blue plotline corresponds to track height 15.875, and the magenta plotline corresponds to track height 19.05;

FIG. 6C illustrates an example of a plot 620 showing a 3-D FEA calculated thrust force, F_{z}, a a function of EDW rotor offset, z_{g}, and track-side height, l_{y}, when the angular speed is ω=5000 r/min, in which the geometric and material values shown in Table I and Table II were used, and where the dark blue plotline corresponds to track height 0.0, the orange plotline corresponds to track height 3.175, the yellow plotline corresponds to track height 6.35, the purple plotline corresponds to track height 9.525, the green plotline corresponds to track height 12.7, the light blue plotline corresponds to track height 15.875, and the magenta plotline corresponds to track height 19.05;

FIG. 7 illustrates an example of a front-view of a centered radial EDW-vehicle 700 with a U-track topology 710, along with two BLDC motors 720 used to rotate the magnets;

FIG. 8A illustrates an example of a plot 800 of EDW-maglev vehicle lateral force, F_{zc}, as a function of track-side height, l_{y}, and lateral offset, z_{c}, where FEA calculation performed when ω=5000 r/min and y_{g}=7 mm, and where the dark blue plotline corresponds to track height 0.0, the orange plotline corresponds to track height 3.175, the yellow plotline corresponds to track height 6.35, the purple plotline corresponds to track height 9.525, the green plotline corresponds to track height 12.7, the light blue plotline corresponds to track height 15.875, and the magenta plotline corresponds to track height 19.05, and where the blue plotline corresponds to thrust force and the orange plotline corresponds to lift force;

FIG. 8B illustrates an example of a plot 810 of EDW-maglev vehicle lift force, F_{yc}, as a function of track-side height, l_{y}, and lateral offset, z_{c}, where FEA calculation performed when ω=5000 r/min and y_{g}=7 mm, and where the dark blue plotline corresponds to track height 0.0, the orange plotline corresponds to track height 3.175, the yellow plotline corresponds to track height 6.35, the purple plotline corresponds to track height 9.525, the green plotline corresponds to track height 12.7, the light blue plotline corresponds to track height 15.875, and the magenta plotline corresponds to track height 19.05;

FIG. 8C illustrates an example of a plot 820 of EDW-maglev vehicle thrust force, F_{xc}, as a function of track-side height, l_{y}, and lateral offset, z_{c}, where FEA calculation performed when ω=5000 r/min and y_{g}=7 mm, and where the dark blue plotline corresponds to track height 0.0, the orange plotline corresponds to track height 3.175, the yellow plotline corresponds to track height 6.35, the purple plotline corresponds to track height 9.525, the green plotline corresponds to track height 12.7, the light blue plotline corresponds to track height 15.875, and the magenta plotline corresponds to track height 19.05;

FIG. 9 illustrates an example of a plot 900 of four-rotor radial EDW-maglev vehicle lateral force vs. track height, l_{y}, when the EDW rotor is offset by z_{c}=−5 mm and when the angular speed is ω=5000 r/min. and the air-gap is maintained at y_{g}=7 mm;

FIG. 10A illustrates an example of a plot 1000 of four-rotor radial EDW-maglev thrust and lift force as a function of track-side height, l_{y}, when the EDW-maglev vehicle is not offset, z_{c}=0 mm, the air-gap is y_{g}=7 mm, and the angular speed is ω=5000 r/min;

FIG. 10B illustrates an example of a plot 1010 of four-rotor radial EDW-maglev lift-to-weight ratio as a function of track-side height, l_{y}, when the EDW-maglev vehicle is not offset, z_{c}=0 mm, the air-gap is y_{g}=7 mm, and the angular speed is ω=5000 r/min;

FIG. 10C illustrates an example of a plot 1020 of four-rotor radial EDW-maglev lift specific power as a function of track-side height, l_{y}, when the EDW-maglev vehicle is not offset, z_{c}=0 mm, the air-gap is y_{g}=7 mm, and the angular speed is ω=5000 r/min;

FIG. 11A illustrates an example of a maglev vehicle 1100 travelling along a 11-meter length L-track, where the rotors are wirelessly controlled and driven by brushless DC motors.

FIG. 11B illustrates an example of a four-rotor radial rotor EDW maglev vehicle 1110, where the rotors are wirelessly controlled and driven by brushless DC motors.

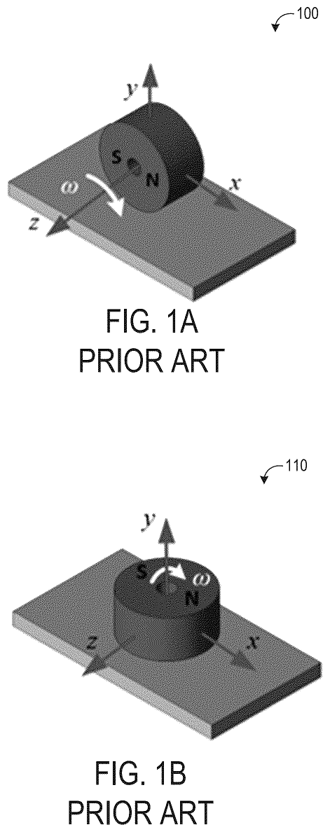

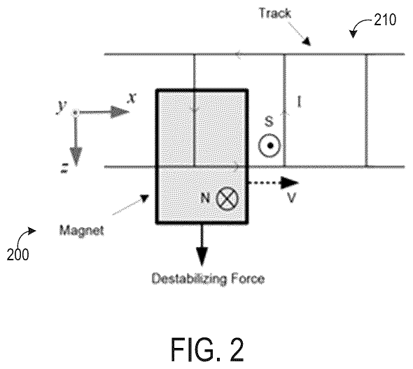

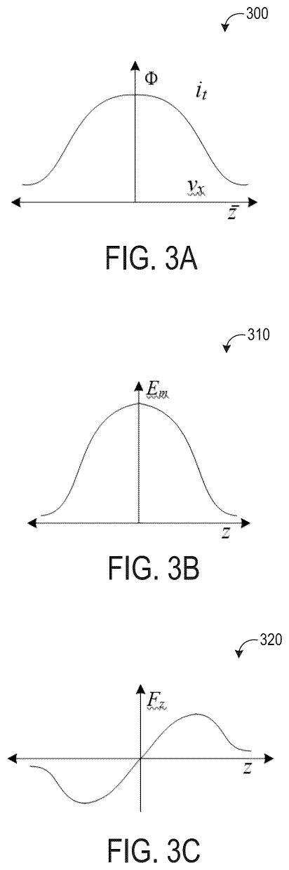

### DETAILED DESCRIPTION

Embodiments of the disclosed technology are generally directed to an L-track electrodynamic wheel (EDW) typology in which two L-tracks are combined to form a U-guideway and an EDW-maglev vehicle can have 6-degrees-of-freedom stability. Each EDW can be composed of a simple one pole-pair diametrically magnetized rotor magnet. In certain alternative embodiments, a higher number of EDW rotor pole-pairs can be used.

### L-Track Force Analysis

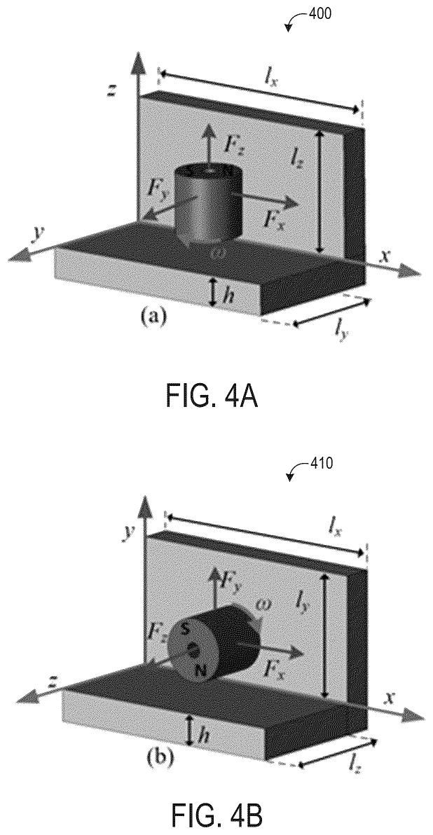

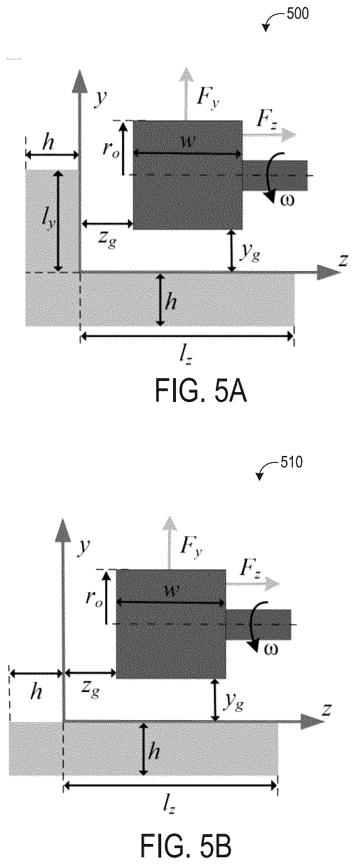

As described herein, the radial and axial EDW forces are defined using the coordinate axis with respect to the rotor axis shown in FIG. 4. A front-view of one radial EDW showing the offset length, z_{g}, and track height, l_{y}, definitions is shown in FIG. 5A and FIG. 5B illustrates a case where the track is flat, l_{y}=0.

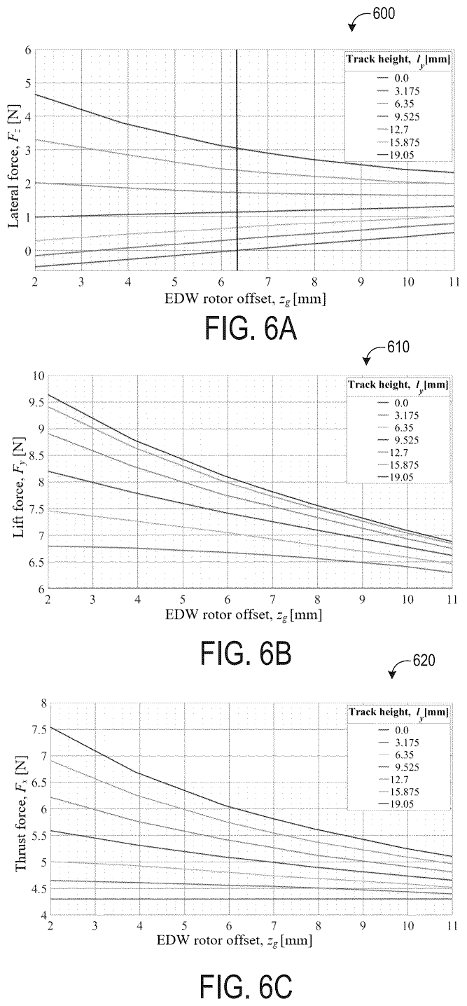

Using the geometric parameters shown in Table I and Table II below, the forces created between the L-track and the rotating one-pole pair EDW were computed using a 3-D transient finite element analysis (FEA) model developed in JMAG. FIG. 6 illustrates a plot of the steady-state force components as a function of EDW rotor offset as well as track height. The forces were computed for the case when ω=5000 r/min and (vₓ, v_{y}, v_{z})=(0, 0, 0).

FIG. 6A shows that when the rotor is axially centered, z_{g}=6.35 mm with l_{y}=0, the axial force is zero. But when l_{y}=0, the EDW has a negative stiffness, and any lateral offset will cause the lateral force to increase in the direction of motion, leading to the EDW exiting the track. When there is a vertical side height on the track, the side track creates an additional axial force, F_{z}, the direction of this force depends on the height of the side-track. Interestingly, as the track-side height increases the stiffness changes from a negative (unstable), to positive (stable) stiffness. For the geometry given, this occurs when the track-side height is l_{y}≥10.9 mm; lateral force is then created that still pushes the rotor off the track, but only in the positive z-axis direction.

TABLE 1
SIMULATION AND EXPERIMENTAL
MATERIAL PROPERTIES

| Parameter | Value | Units |
|---|---|---|
| Track conductivity, σ | 2.5 × 10⁷ | S/m |
| Magnet residual flux | 1.32 | T |
| density, Bᵣₘ | | |
| Magnet relative | 1.055 | — |
| permeability, μᵣ | | |
| Magnet mass, m | 0.0905 | kg |

TABLE 2
SIMULATION SWEEP PARAMETERS
AND EXPERIMENTAL VALUES

| | FEA | |
|---|---|---|
| | simulation | Experimental |
| Parameter | value [mm] | value [mm] |
| Rotor outer | 12.7 | 12.7 |
| radius, rₒ | | |
| Rotor inner | 3.175 | 3.175 |
| radius, rᵢ | | |
| Rotor width, w | 2rₒ | 2rₒ |
| Radial airgap, | 7 | varied |
| y_{g} | | |
| Track thickness, | 12.7 | 6.35 |
| h | | |
| Track length, lₓ | 100 | 2438.4 |
| Track width, l_{z} = | 50.8 | 57.15 |
| 2.5 w | | |
| Rotor offset, z_{g} | [2, 1, 11] | 0 |
| Track-side | 3.175 · [0, 1, 6] | 31.75 |
| height, l_{y} | | |

FIGS. 6B and 6C illustrate the effect of rotor offset on the lift force and thrust force, respectively. When l_{y}=0 the lift and thrust force do not perceptively change with rotor offset, this is only because the rotor is not sufficiently close to the track edge. The increase in track-side height increases the lift and thrust force. When the rotor is at the minimum offset of zₜ=2 mm the lift force increases from 6 N to 9.6N, a 60% increase, while the thrust force increased from 4.3 N to 7.5 N, a 74% increase. Therefore, while the presence of the side-track increases loss, it also significantly increases the lift-to-weight ratio as well as thrust force.

### EDW Vehicle With a U-Guideway

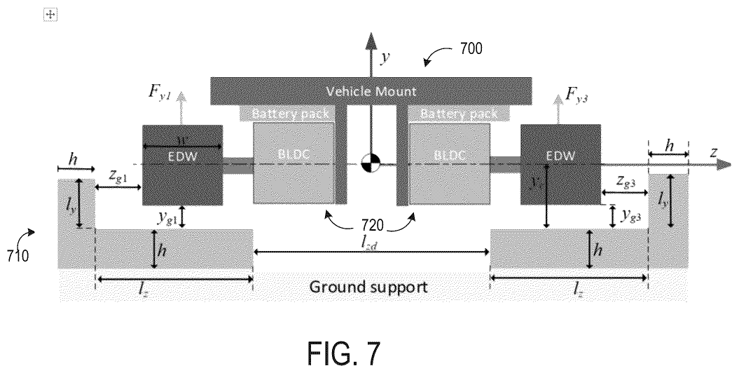

To create a recentering force regardless of axial position, a U-track guideway can be used. A front-view of a U-track EDW maglev that contains radial EDWs is shown in FIG. 7. Also illustrated by FIG. 7 are the brushless DC motors and the vehicle mounts. In the following radial EDW analysis, the vertical height of the EDWs is fixed at y_{g}=7 mm and the vehicle is assumed to be laterally centered when:

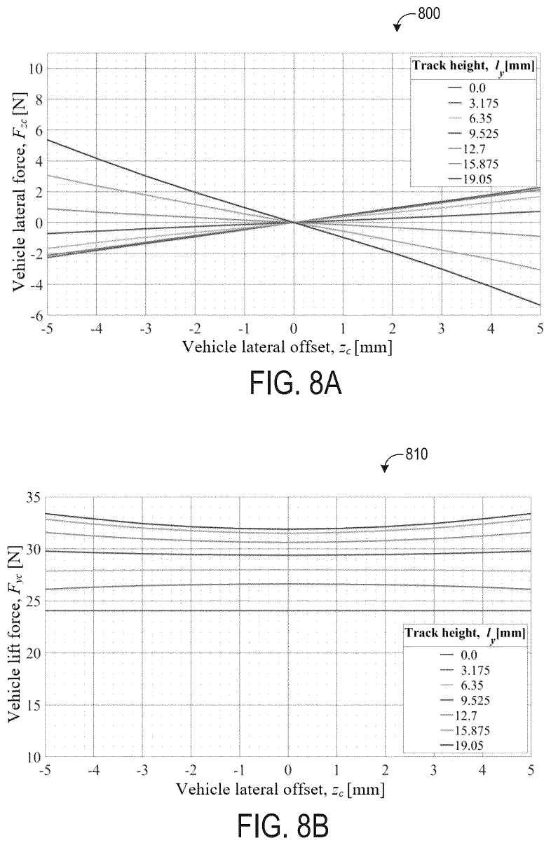

z_{g1}=z_{g2}=z_{g3}=z_{g4}=6.35 mm Eq. (5)

where z_{g1} and z_{g2} are the distances from the EDW and left-side track and z_{g3} and z_{g4} are the distances from the right-side track. Only the z_{g1} and z_{g3} distances are shown in the front-view in FIG. 7. When equation (5) is satisfied, the net lateral force is zero. The 3-D FEA calculated change in lateral force as well as lift and thrust as the vehicle is laterally offset is illustrated by FIG. 8. Also shown is the change in the force with respect to track-side height, l_{y}. The vehicle lateral offset can be defined as:

z_{c}=(z_{g1}+z_{g2}−z_{g3}−z_{g4})/4 Eq. (6)

The EDW rotor's thrust and lift force add when the rotors are offset, and the vehicle lateral force can be defined as:

F_{zc}(z_{c})=F_{z1}(z_{g1})+F_{z2}(z_{g2})−F_{z3}(z_{g3})−F_{z4}(z_{g4}) Eq. (7)

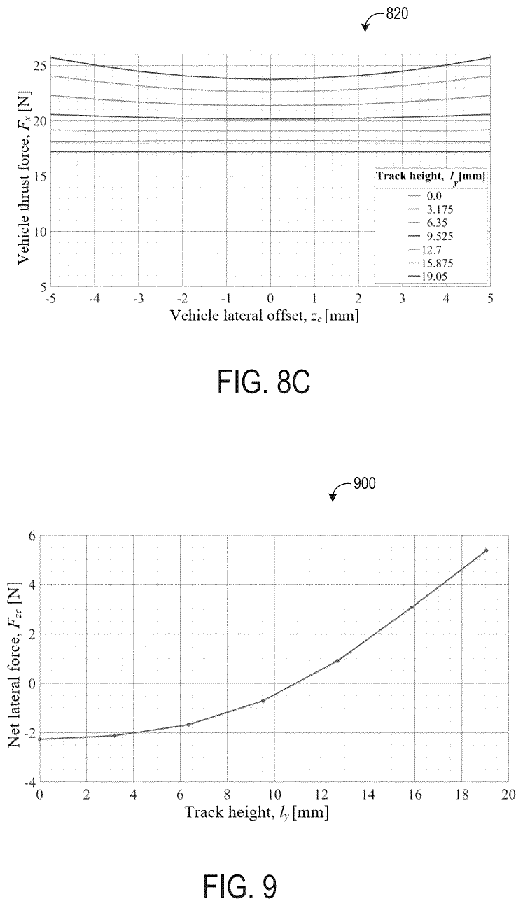

The EDW-vehicle recentering axial force is highly linear and the calculated axial stability occurs when l_{y}≥10.9 mm. This cross-over length can be more clearly seen in FIG. 9 in which the total axial force at the offset position z_{c}=−5 mm is shown.

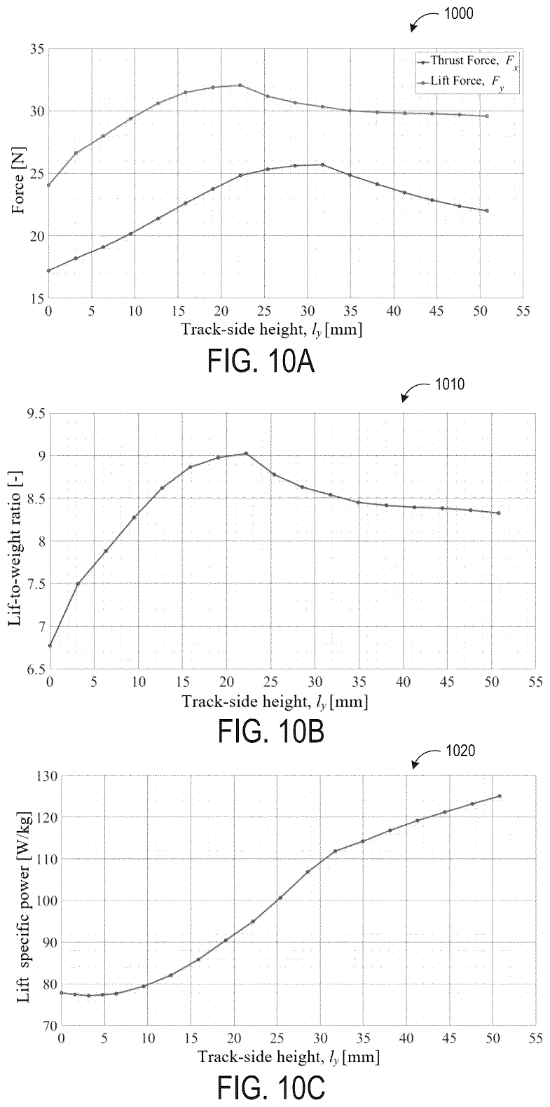

FIGS. 8B and 8C illustrate how the thrust and lift force increases as the track-side height increases, these force components are almost decoupled from the lateral offset. FIG. 10A illustrates that the thrust and lift force peak as the track height is increased. Based on the simulation conditions and geometry used in this paper the track height that gave the peak thrust and peak lift occurred when l_{yx}=y_{g}+1.95rₒ=31.75 mm and l_{yy}=y_{g}+1.2rₒ=22.23 mm, respectively. To maximize the lift force the side track-height should be lower than the EDW diameter.

The increase in lift as the track-side height increases improves the lift-to-weight ratio, this improvement is illustrated by FIG. 10B. The lift-to-weight ratio can be defined by:

$$\\ \begin{matrix}{L}_{w} = \frac{{F}_{y}}{mg} & Eq . ( 8 )\end{matrix}$$

where m=magnet mass. The lift force is created from the currents induced on the track edge, pushing the EDW upwards, off the track edge. This increase in lift comes at an increase in lift specific power (W/kg), as illustrated by FIG. 10C.

The lift specific power can be defined as:

$$\\ \begin{matrix}{S}_{w} ( {v}_{x} ) = \frac{{P}_{L}}{{F}_{y} / g} [ W / kg ] & Eq . ( 9 )\end{matrix}$$

where P_{L}=total electrical track loss. It should be noted that the lift specific power is relatively high. This is because of the small diameter used as well as the high angular speed selected for the force analysis.

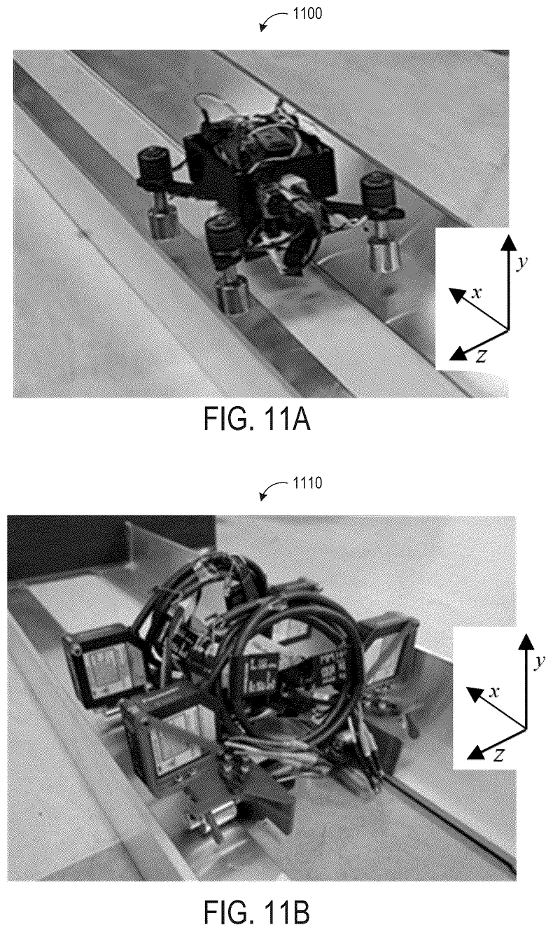

An axial EDW-maglev vehicle and a radial EDW-maglev vehicle are illustrated by FIGS. 11A and 11B, respectively, and the geometric parameters used in these experimental setups are shown in Table I and II above. The axial and radial vehicle mass is mₐ=1.32 kg and mᵣ=1.82 kg, respectively. The radial EDW is heavier due to the vehicle also containing four height laser sensors. The vehicles were wirelessly operated and can linearly travel along the U-guideway. The stability at a range different operating speeds as well as the vehicle heights can be measured using laser sensors.

Maglev vehicles that use translationally moving magnets to create electrodynamic levitation can experience instability at different operating speeds. As the EDW vehicle has a slip speed, as well as translational speed, and these two speeds can be independently changed the EDW vehicle could more easily overcome instability induced at particular operating speeds.

In an exemplary embodiment, an electrodynamic wheel (EDW) vehicle can include: a vehicle mount configured to transport a load such as cargo, passengers, or both; a plurality of motors mechanically coupled with the vehicle mount; at least one battery mechanically coupled with the vehicle mount and configured to provide power to the plurality of motors; and a plurality of EDWs coupled with the vehicle mount, wherein each of the plurality of EDWs includes a magnet and a rotor configured to be rotated by a corresponding one of the plurality of motors, further wherein the EDWs are configured to magnetically levitate over a U-guideway.

In certain examples of the EDW vehicle, the plurality of motors includes brushless direct current (BLDC) motors. In additional examples of the EDW vehicle, the plurality of EDWs includes four radial rotors. In some examples of the EDW vehicle, the plurality of EDWs includes four axial rotors.

In certain embodiments of the EDW vehicle, the U-guideway includes a plurality of sections of L-track; the plurality of sections of L-track includes aluminum sheets; alternatively or in addition thereto, the plurality of sections of L-track are configured to provide lateral recentering force; alternatively or in addition thereto, the plurality of sections of L-track are configured to increase thrust and lift force. Each rotor may be controlled via wired or wireless mechanisms

In another embodiment, a system can include a U-guideway and an electrodynamic wheel (EDW) vehicle, the EDW vehicle having: a vehicle mount configured to transport a load; a plurality of motors mechanically coupled with the vehicle mount; at least one battery mechanically coupled with the vehicle mount and configured to provide power to the plurality of motors; and a plurality of EDWs coupled with the vehicle mount, wherein each of the plurality of EDWs includes a magnet and a rotor configured to be rotated by a corresponding one of the plurality of motors, further wherein the EDWs are configured to magnetically levitate over the U-guideway. In some aspects, the plurality of motors includes brushless direct current (BLDC) motors. In additional aspects, the plurality of EDWs may include a plurality of rotors, for example four radial rotors and or axial rotors.

In certain embodiments of the system, the U-guideway includes a plurality of sections of L-track; the plurality of sections of L-track includes aluminum sheets; alternatively or in addition thereto, the plurality of sections of L-track are configured to provide lateral recentering force; alternatively or in addition thereto, the plurality of sections of L-track are configured to increase thrust and lift force.

The description of embodiments has been presented for purposes of illustration and description. Suitable modifications and variations to the embodiments may be performed in light of the above description or may be acquired from practicing the methods. The methods may be performed by executing stored instructions with one or more logic devices (e.g., processors) in combination with one or more hardware elements, such as storage devices, memory, hardware network interfaces/antennas, switches, actuators, clock circuits, and so on. The described methods and associated actions may also be performed in various orders in addition to the order described in this application, in parallel, and/or simultaneously. The described systems are exemplary in nature, and may include additional elements and/or omit elements. The subject matter of the present disclosure includes all novel and non-obvious combinations and sub-combinations of the various systems and configurations, and other features, functions, and/or properties disclosed.

As used herein, the terms “system” or “module” or “modulator” may include a hardware and/or software system that operates to perform one or more functions. For example, a module or system may include a computer processor, controller, or other logic-based device that performs operations based on instructions stored on a tangible and non-transitory computer readable storage medium, such as a computer memory. Alternatively, a module or system may include a hard-wired device that performs operations based on hard-wired logic of the device. Various modules or units shown in the attached figures may represent the hardware that operates based on software or hardwired instructions, the software that directs hardware to perform the operations, or a combination thereof.

The foregoing described aspects depict different components contained within, or connected with different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected,” or “operably coupled,” to each other to achieve the desired functionality.

As used in this application, an element or step recited in the singular and proceeded with the word “a” or “an” should be understood as not excluding plural of said elements or steps, unless such exclusion is stated. Furthermore, references to “one embodiment” or “one example” of the present disclosure are not intended to be interpreted as excluding the existence of additional embodiments that also incorporate the recited features. The terms “first,” “second,” “third,” and so on are used merely as labels, and are not intended to impose numerical requirements or a particular positional order on their objects. The following claims particularly point out subject matter from the above disclosure that is regarded as novel and non-obvious.

1. An electrodynamic wheel (EDW) vehicle, comprising:
a vehicle mount configured to transport a load;
a plurality of motors mechanically coupled with the vehicle mount;
at least one battery mechanically coupled with the vehicle mount and configured to provide power to the plurality of motors; and
a plurality of EDWs coupled with the vehicle mount, wherein each of the plurality of EDWs includes a magnet and a rotor configured to be rotated by a corresponding one of the plurality of motors, further wherein the EDWs are configured to magnetically levitate over a U-guideway.

2. The EDW vehicle of claim 1, wherein the plurality of motors includes brushless direct current (BLDC) motors.

3. The EDW vehicle of claim 1, wherein the plurality of EDWs includes four radial rotors.

4. The EDW vehicle of claim 1, wherein the plurality of EDWs includes four axial rotors.

5. The EDW vehicle of claim 1, wherein the U-guideway includes a plurality of sections of L-track.

6. The EDW vehicle of claim 5, wherein the plurality of sections of L-track includes aluminum sheets.

7. The EDW vehicle of claim 5, wherein the plurality of sections of L-track are configured to provide lateral recentering force.

8. The EDW vehicle of claim 5, wherein the plurality of sections of L-track are configured to increase thrust and lift force.

9. The EDW vehicle of claim 1, wherein the load includes cargo, passengers, or both.

10. The EDW vehicle of claim 1, wherein each rotor is wirelessly controlled.

11. A system, comprising:
a U-guideway; and
an electrodynamic wheel (EDW) vehicle having:
a vehicle mount configured to transport a load;
a plurality of motors mechanically coupled with the vehicle mount;
at least one battery mechanically coupled with the vehicle mount and configured to provide power to the plurality of motors; and
a plurality of EDWs coupled with the vehicle mount, wherein each of the plurality of EDWs includes a magnet and a rotor configured to be rotated by a corresponding one of the plurality of motors, further wherein the EDWs are configured to magnetically levitate over the U-guideway.

12. The system of claim 11, wherein the plurality of motors includes brushless direct current (BLDC) motors.

13. The system of claim 11, wherein the plurality of EDWs includes four radial rotors.

14. The system of claim 11, wherein the plurality of EDWs includes four axial rotors.

15. The system of claim 11, wherein the U-guideway includes a plurality of sections of L-track.

16. The system of claim 15, wherein the plurality of sections of L-track includes aluminum sheets.

17. The system of claim 15, wherein the plurality of sections of L-track are configured to provide lateral recentering force.

18. The system of claim 15, wherein the plurality of sections of L-track are configured to increase thrust and lift force.

19. The system of claim 11, wherein the load includes cargo, passengers, or both.

20. The system of claim 11, wherein each rotor is wirelessly controlled.
